(19) United States
(12) Patent Application Publication
(10) Pub. No.: US 2024/0322641 A1
(43) Pub. Date: Sep. 26, 2024

(54) Case lid for a case of an electric motor, case assembly having the case lid and electric motor

(71) Applicant: Webasto SE, Stockdorf (DE)

(72) Inventor: Werner Lissner, Stockdorf (DE)

(21) Appl. No.: 18/614,239

(22) Filed: Mar. 22, 2024

(30) Foreign Application Priority Data
Mar. 23, 2023 (DE) 102023202670.8

(51) Int. Cl. H02K 5/22; H02K 5/24

(52) U.S. Cl. CPC H02K 5/22; H02K 5/24

(57) ABSTRACT

A case lid for a case assembly of an electric motor for driving a movable component in a vehicle, comprises an at least partially planar lid wall having an inner face facing a case of the case assembly in a mounted state and a corresponding outer face facing away from the case, both faces each comprising an edge, and one or more engagement structures connected with the case lid for coupling corresponding engagement structures provided at the case, in order to close an opening of the case.

### CROSS-REFERENCE TO RELATED APPLICATION

This application claims priority to German Application No. DE 10 2023 202 670.8 filed on Mar. 23, 2023, which is incorporated herein by reference in its entirety for all purposes.

### TECHNICAL FIELD

Various aspects relate to a case lid for a case of an electric motor, in particular for driving a movable component in a vehicle, such as a sliding roof or sunroof or a roller blind, window regulator, etc. Further aspects relate to a case assembly comprising the case lid and also to an electric motor having the case assembly.

### TECHNICAL BACKGROUND

Electric motors, such as those used to drive a moving component in a vehicle, commonly include a case (or case assembly) that has multiple functions. For example, the case serves to make the motor compact, integrates a control unit, motor and gearbox, provides protection against dirt and external mechanical damage, provides the necessary electrical insulation or ensures a certain degree of damping of vibrations that can lead to unwanted noise, etc.

Electric motors (e.g. DC motors designed as brush motors or BLDC motors) for movable components in a vehicle may include a case comprising one or more basic components with separate chambers for the actual motor, the gearbox and the electrical control. According to one example, the basic components may comprise a transmission casing and a motor casing to be attached to it. The gearbox casing has an opening that can be closed by a case lid through which the respective components, for example of the gearbox such as a rotor shaft, can be inserted during assembly. The motor casing having the motor components (for example the stator) mounted in it is then fitted in a suitable position so that the stator and rotor come together. The case lid is then fitted to close the opening.

The operation of the motor causes vibrations that are transmitted to the case, to which components of the motor are firmly connected. The aim is to absorb vibrations propagating in the material of the case (e.g. plastic or a resin). When designing the case, care is therefore also taken to ensure that, in particular, no case parts vibrating at a natural or resonant frequency may arise that might transmit the vibrations to the environment as unwanted sound.

Case lids for the respective cases are usually designed as flat components. They often have a flat lid wall, the flatness of which is highly desirable for smooth mounting of, for example, a circuit board of the electronic control unit to be arranged under the lid. Only the attachment means for fastening a case lid to the base component or those sections of the case lid surrounding the base component of the case may protrude significantly from such plane. The case lid therefore requires a sufficient degree of rigidity, even in the middle of a face of the lid wall, in order to avoid mechanical interaction with components located under the case lid and thus to protect them.

Such increased rigidity can be achieved, for example, by a pattern of webs. FIG. 1 shows an example of such a pattern of webs or ribs of a conventional type, which is formed on an essentially flat lid wall of a case lid. Such a pattern of webs defining intermediate recesses therebetween is formed over almost the entire surface of the otherwise basically flat outer face. On the inner face, which is not shown, the same pattern may regularly be formed in a mirror-symmetrical manner (mirroring across the plane of the lid) so that no distortion occurs when cooling after injection molding during the manufacturing process. Arrangements of parallel webs extend in a first direction and in a second direction perpendicular to the first direction, so that the reinforcement is essentially independent from the direction. The distance between the webs is the same everywhere in the pattern, so that a shape of a regular grid is obtained. In practice, this measure results in a very stable case lid having a flat lid wall that conforms to a plane.

However, when using such a pattern, especially with electric motors that are designed to operate components in the vehicle in terms of size and design, parts of the lid may vibrate, resulting in unwanted noise. Particularly in the case of motors for the operation of movable components in the vehicle roof, this noise development is sometimes easily audible and therefore particularly unpleasant.

There is thus a need to provide a case lid that is not only mechanically reinforced but also reduces noise when vibrations are transmitted and propagate.

Document DE 10 2020 108 200 A1 discloses a case lid for an inverter cover, also referred to therein as a bottom wall, which defines a space adjacent to a motor casing component and in which an inverter for a motor-driven compressor is arranged, which in turn is part of a refrigeration circuit for a vehicle air conditioning system. The case lid has an inner surface and an outer surface. Patterns of ribs are arranged on both surfaces, which intersect perpendicular to each other and thus form a grid. The two rib patterns are spaced apart from a peripheral wall, the opening of which is closed by the case lid, and in particular from bolts in this wall. This spacing considerably limits the transmission of vibrations from the motor casing via the peripheral wall to a central area in which the rigidity of the case lid is increased by the rib pattern.

Document CN 107342652 A discloses a wind shield with a fan opening arranged in a centre thereof, which closes off the rear of a case of a 3-phase asynchronous motor and helps to cool the motor coils. Ribs extending spirally from the center of the fan opening towards the edge are arranged in the wind shield. These ribs are intended to mechanically reinforce the wind shield and at the same time help to reduce vibrations and thus undesirable noise development. The width of the ribs is no more than 1 mm and the thickness of the respective wind shield plate is 2-3 mm.

Document EP 2 557 667 A1 discloses a control case that accommodates, among other things, an inverter for an electric motor for a pump unit. The control case has a case body and a case lid. Cooling fins extending parallel to each other in the longitudinal direction are arranged at the case lid to support dissipation of heat. A pattern with a homogeneous distribution of honeycomb-shaped ribs is formed exclusively on the sides of the case body (and not on the case lid or on a contact side to a motor frame), which form part of a vibration suppression structure in combination with a closure plate attached to the case lid. At these sides, however, the pattern of honeycomb-shaped ribs need not be formed over the entire surface but only in partial areas.

The publication U.S. Pat. No. 5,696,415 A discloses an electric generator for a vehicle. A rear cover protects electrical components such as brushes, rectifiers, regulators and the like, which are attached to a rear frame of the electric generator. The rear frame is connected to a front frame, and a stator and a rotor are accommodated in a space between the two. Two support portions allow that the frames are fixed to each other with bolts and nuts. Air inlet windows for cooling air are formed on opposite sides of the front and rear frames. Air outlet windows for the cooling air heated during operation are formed in the connecting side surfaces of both frames. The air outlet windows are divided by reinforced window ribs. Close to the support portions, the window ribs have a greater width compared to the other ribs in order to create a rigidity that helps to prevent the transmission of magnet vibrations generated in the stator to the frames.

### SUMMARY OF THE INVENTION

Aspects of the invention, which account for the above mentioned needs, relate to a case lid for a case assembly of an electric motor, in particular for driving a movable component in a vehicle, such as a sliding or sunroof or a roller blind. The proposed case lid comprises an at least partially planar lid wall having an inner face facing the case in a mounted state of the case lid and an outer face facing away from the case, both the inner face and the outer face comprising a peripheral edge. Moreover, the case lid comprises one or more engagement structures connected to the lid wall for coupling with corresponding engagement structures configured at the case, to fix the case lid to the case of the case assembly and to close an opening in the case. On the inner face and the outer face a pattern of elevated webs providing rigidity to the lid wall and recesses formed therebetween and defined by the webs is arranged. According to the aspects proposed herein, the pattern comprises a number of first webs extending radially outwards to the edge from a region within the inner face and/or the outer face, respectively. Furthermore the pattern comprises second webs intersecting the first webs in a transverse direction. The radially extending first webs are thereby each laterally offset in sections thereof along the radial direction.

By this structure of the pattern, a region is provided within the inner face and the outer face, respectively, which serves as a starting point for the webs extending radially outwards and towards the peripheral edge. In other words, the webs converge towards this region and become more dense. This region is preferably positioned close to a centre of the inner and outer face, respectively, and includes a distance to the peripheral edge. Each elevated web does not only lead to a contribution to rigidity of the lid wall, but also locally increases the amount of material, which is to be moved in a case of vibration or oscillation. The agglomeration of the converging webs towards the thus defined region thus leads to a concentration of the amount of material brought along by the webs towards the centre of the inner and outer faces, respectively.

Such increase in the mass of material accumulated in the centre of the lid wall per se leads to a change in the oscillation spectrum of the case lid, when it is excited to oscillate by the vibrations transmitted from the actual motor via the case.

In the same breath, these aspects provide for the first webs extending radially outwards to be each laterally offset in sections thereof. Each of the first webs may thus for example assume an alternating or meandering form with regard to a straight line extending radially outwards. It is important hereby, that, if possible, no first web extends entirely straight and linear from the edge towards the centre (or the region, respectively). Preferably, none of laterally offset web sections extends within radial projection of an adjacent web section of the same radial web, which is adjoining inwards or outwards.

Namely, it has been found out, that in case of a conventional arrangement of webs, those webs which extend continuously linear may cause an undesired but unfortunately effective transmission and propagation of oscillations or vibrations towards the centre of the inner and outer faces, respectively. Due to the lateral offset of the sections of each first web as proposed herein such a direct transmission is avoided. Rather, the vibrations introduced from the case via the edge propagate transversely (with respect to a radial line) at the end of each section, in order to arrive at a next adjoining section of the corresponding radial web. This in turn leads to an increased dispersion of the vibrational waves as well as to an increased damping by the accumulating lid material. Measurements reveal, that by the combination of both measures-webs extending radially from the central region of the inner and outer face, respectively, and its sectional offset-sufficient rigidity can be achieved while a level of noise emission originating from the case lid may still be decreased.

According to some specific embodiments, the overall noise level can be reduced by 1-3 dB. In particular, however, the levels of the peaks in the spectrum can be flattened by up to 5 dB, whereby it is precisely these peaks-which correspond to the resonant vibrations of the case lid—that create a problem with regard to the specifications of the manufacturer of the vehicle, in whose vehicles the corresponding electric motor is to be installed.

Furthermore, the aspects as proposed herein allow to provide a noise-reduced case lid without having to implement additional components for noise damping or absorption in or on the case, as the specifications (see above) are also met without these. This enables a reduction in the number of parts, the costs and the process time required for assembly.

According to an embodiment the second webs extending in a direction transverse to the radial direction and intersecting the first webs are arranged concentric with respect to each other and extend each annularly and in a predetermined distance to the region at or near the centre of the inner face or the outer face, respectively. Due to this, a pattern is enabled, in which the first webs extending radially are divided in the same manner, which in turn supports defining sections, which reveal the lateral offset in a circumferential direction, respectively. The second webs thereby represent the connection between the laterally offset web sections with adjoining web sections of the same first web in the transverse (circumferential) direction.

In a particular embodiment of this aspect, the pattern has a rotational symmetry with a centre of rotation in the region within the inner face or the outer face, respectively. Rotational symmetry here means that there are a number of fixed rotation angles at which the pattern is mapped onto itself with respect to the first and second webs during an imaginary rotation (this does not pertain to additional webs which may be provided at or adjacent to the edge of the inner or outer face of the lid wall, respectively, or in a vicinity of openings, recesses or protrusions in the lid wall). With this form of pattern, the density of webs decreases in all directions outwards. Apart from the functional advantage, it is also more visually appealing than an irregular arrangement, which is, however, not excluded according to other embodiments.

According to another embodiment, an opening extending through the lid wall may be formed in the distance from the edge within the inner face or the outer face, respectively. Such an embodiment may provide for the centre of rotation of the rotational symmetric pattern being located in the centre of the opening. The above defined region, which serves as the starting point for the radially extending first webs, may in such a case be represented by surroundings or a vicinity of that opening. Such openings commonly additionally include a stiffened edge, such that the integration of such opening as a centre of the pattern becomes particularly advantageous. One such opening may for example simultaneously serve for fixation of the electric motor at a frame part of for example a (movable) roof of the vehicle (by virtue of fixation means such as screws inserted through the openings). Such a roof may be driven for example via a gear of the motor.

In a further embodiment the pattern of webs and of recesses at least partially enclosed by the webs occupies a fraction of the surface area of the inner face or the outer face, respectively, in the planar part of the lid wall. The fraction of the surface area may hereby amount to at least 80%, preferably at least 90%.

Alternatively or additionally, a local fraction of a surface area occupied by the first and second webs in relation to a surface area of these webs and the recesses enclosed by the webs may substantially decrease with increasing distance from the above defined region close to the centre of the inner face or the outer face. “Substantially” hereby means that narrow interim rises may be possible—for example due a situation in which the above defined local fraction is considered at a radius corresponding to a distance of the second webs from the centre of rotation of the region, if the second webs are arranged concentrically, wherein such local fraction may then amount to 100% over the width of the respective second web. Also, the local fraction may be increased at the peripheral edge of the lid wall. Preferably, in case of rotational symmetry of the pattern a local fraction of the first and second webs in a first inner circular ring (between two adjacent second webs) around the centre of rotation may amount to more than 60%, and may amount to less than 40% in a second circular ring (between two adjacent second webs) located more outwardly as compared to the first circular ring.

According to embodiments the case lid may be manufactured from a plastic material or a resin and may be injection molded. In such a case, the injection mold may advantageously be adapted only once, in order to achieve the goals for a plurality of manufactured case lids. Moreover, the case lid may be formed as a single piece. The advantage has already been described above. In specific embodiments, the inner face as well as the outer face of the lid wall may include the pattern in the same manner. The centre of rotation may thereby be positioned at corresponding opposing locations on the inner and outer faces, respectively. However different locations may be possible as well.

A further aspect of the present invention provides for a case assembly for an electric motor for driving a movable component in a vehicle, in particular a sliding roof or a sunroof or a roller blind, comprising a case lid according to one of the above-described aspects or embodiments.

Furthermore, an electric motor for driving the movable component in a vehicle, in particular a sliding roof or a sunroof or a roller blind, may preferably comprise a DC motor, the case assembly according to above mentioned further aspect, as well as a gearbox, a control unit and electronic components operated by the control unit, in particular a stator and rotor.

Further advantages, features and details of the various aspects become apparent from the claims, the following description of preferred embodiments as well as from the drawings. In the figures the same reference numerals denote the same features and functions.

### BRIEF DESCRIPTION OF THE DRAWINGS

Therein,

FIG. 1 shows a perspective view of a comparative example of a case lid in which a substantially (mirror-)symmetrical pattern is formed from webs reinforcing the structure and recesses formed between them;

FIG. 2 shows a diagram that shows a distribution of the strength of vibrations or oscillations over the case lid of FIG. 1, which is placed on an associated case of an electric motor;

FIG. 3: shows in a similar perspective view as in FIG. 1, a case lid according to an embodiment of the present invention, in which a substantially rotational symmetric pattern having a centre point defined in a central region of an outer face of the case lid is formed;

FIG. 4 shows in a perspective view the case lid of FIG. 3 according to the embodiment, but viewed from an inner side thereof;

FIG. 5 shows in a perspective view the case lid of FIG. 3 or 4 prior to mounting onto a case of an electric motor;

FIG. 6 shows in a perspective view the assembled electric motor of FIG. 5 according to an embodiment;

FIG. 7: shows diagrams with measured or simulated noise levels, plotted over a frequency range from 50 Hz to 10 KHz, for two case lids each according to the conventional design (diagrams on the left) and according to embodiments of the invention (diagrams on the right), with the upper diagrams relating to the clockwise rotation of the motor and the lower diagrams relating to the counterclockwise rotation of the motor.

### DESCRIPTION OF PREFERRED EMBODIMENTS OF THE INVENTION

In the following description of preferred embodiments, it should be noted that the present disclosure of the various aspects is not limited to the details of the structure and arrangement of the components as shown in the following description and in the figures. All embodiments, including those not shown in the figures, can be put into practice or implemented in various ways. Furthermore, it should be noted that the expressions and terminology used herein are used for the purpose of specific description only and should not be interpreted as such in a limiting manner by the skilled person. Furthermore, in the following description, identical reference signs in the figures denote identical or similar features or objects, so that in some cases a repeated detailed description of the same is dispensed with in order to maintain the compactness and clarity of the description.

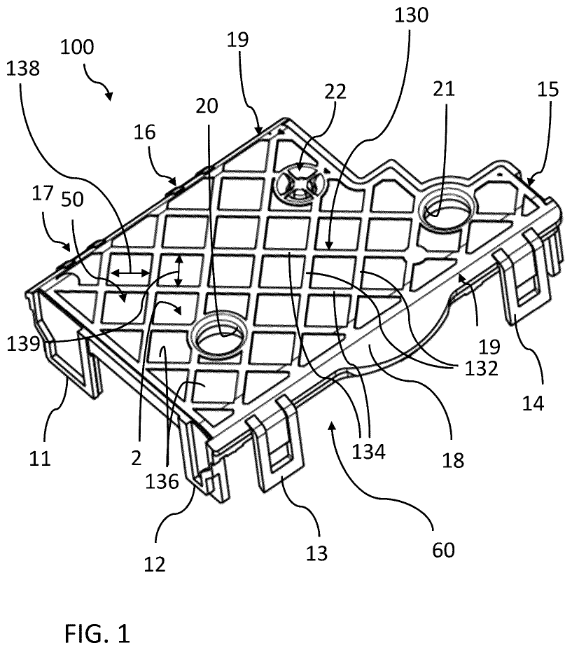

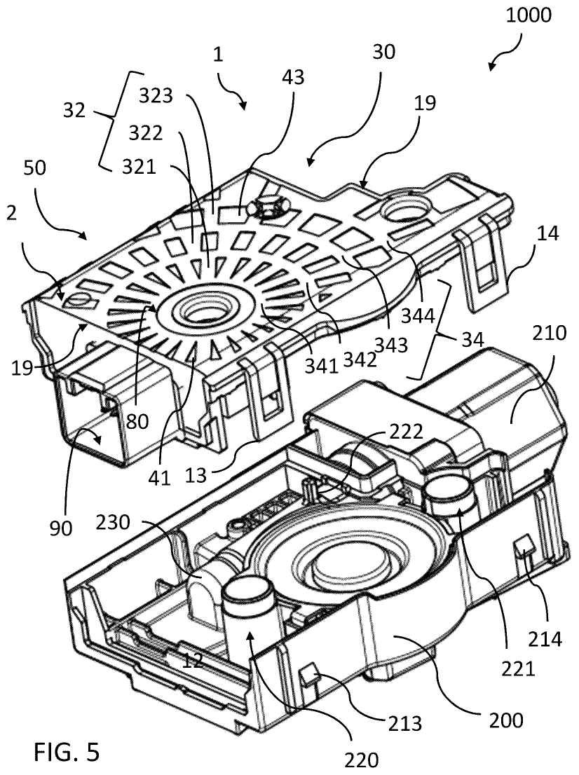

FIG. 1 shows a perspective view of a comparative example of a case lid 100. The case lid 100 is made of a plastic material or a resin in an injection molding process and comprises a substantially flat, planar lid wall 2 and engagement structures 11-17, which engage with corresponding engagement structures (latching lugs 213, 214) provided at a case (gearbox casing 200; only shown in FIG. 5 by way of an embodiment) of an electric motor 1000, here a brushless DC motor, which is set up for operating movable roof components, for example of a motor vehicle. The engagement structures 11-17 may be simple latching tabs (see for example reference numerals 13, 14) or similar structures having guide surfaces (see for example reference numeral 12). The engagement structures 11-17 ensure an easily attachable, reliable and detachable connection of the case lid to the underlying case. The case lid 100 covers an opening in the case through which parts of the gearbox and the electronics of the electric motor can be inserted or replaced. Openings 20, 21, 22 are also formed in the case lid. Openings 20 and 21 are used to allow the entire motor to be attached to a roof frame of a vehicle in question by means of a screw inserted through it once it has been assembled. The opening 22, on the other hand, serves to pre-align the case lid with respect to the case on the inside of the case lid 100 with a corresponding projection provided at the case when mounting the lid at the electric motor. The explanations regarding the openings 20-22 and their functions also apply to the embodiments described below.

It should be noted that in the present application the base body or base bodies which accommodate the motor and gear components and to which the case lid is mounted are collectively also referred to as the case, while the combination of base body (case) and case lid is referred to as the case assembly.

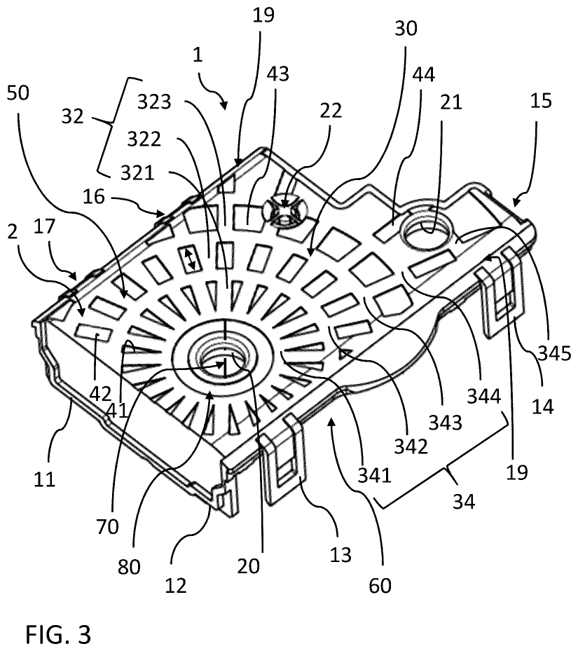

The planar lid wall 2 has a substantially flat inner face 60 and a substantially flat outer face 50, which are opposite each other. In the perspective view of FIG. 1 (and also of FIG. 3 to be explained), the inner face is not directly visible and only indicated by an arrow and the reference numeral. The inner face 60 faces the opening of the case to be closed during assembly, while the outer face 50 visible in the figures is correspondingly facing away from the case positioned below it or is opposite the direction of insertion defined by the engagement structures 11-17.

On the outer face 50, a symmetrical pattern 130 is formed from elevated webs 132, 134 reinforcing the lid structure and intermediate recesses 136 enclosed by the webs 132, 134. In particular, the pattern is formed as a periodic grid having rectilinear webs 132, 134 arranged perpendicular to one another. First webs 132 extend parallel to one another at a same mutual second distance 138, and second webs 134, which run perpendicular to the first webs, extend parallel to one another at a same first distance 139. In the comparative example, the first and second distances 138 and 139 are identical. Accordingly, the recesses between the first and second webs 132, 134 are of square shape. The webs 132, 134 may each have a rectangular or a trapezoidal cross-sectional profile.

The pattern 130 extends almost over the entire surface of the outer face 50 up to the peripheral edge 19. In the specific example, the case lid 100 also has an inclined portion 18 which, starting from the edge 19 of the flat lid wall 2 or the conventional pattern 130, extends slightly out of the plane of the lid wall 2 and is not covered with the pattern 130.

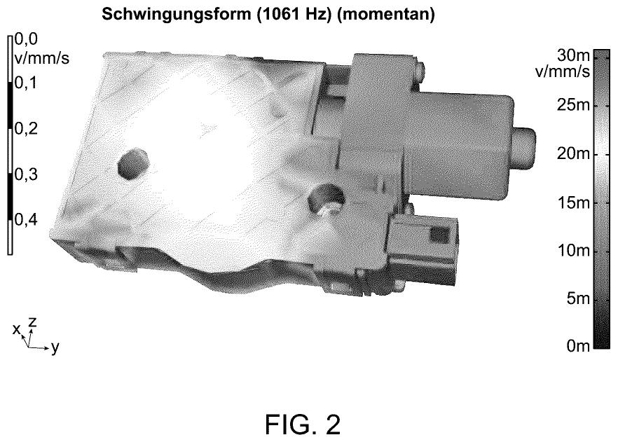

FIG. 2 shows a diagram in which the entire case assembly including the case lid 100 depicted in FIG. 1 according to the comparative example is shown in a perspective view. The amplitude of the vibrations over the outer contour, which were determined in simulations when vibrations are transmitted from a motor mounted inside the case, is shown in gray scale. A vibration mode at 1061 Hz is shown. It can be clearly seen that the largest amplitudes occur in the middle or center of the case lid 100. The case lid 100 acts as a sound-generating vibrating body. Further analysis revealed that the webs 132, 134, which extend linearly through the center of the outer face 50, transmit the vibrations very efficiently and homogeneously to the center, so that the amplitude is comparatively high there.

FIG. 3 shows an embodiment according to the invention. Only the differences with regard to FIG. 1 are described. The case lid 1 basically has a very similar shape to that of the case lid 100 of FIG. 1, with the exception of another pattern 30, now in accordance with the invention, which differs from pattern 130. In particular, however, the lid wall 2, the engagement structures 11-17, the inclined portion 18, the edge 19, and the openings 20, 21, 22 in FIG. 3 correspond to the lid wall 2, the engagement structures 11-17, the inclined portion 18, the edge 19, and the openings 20, 21, 22 of FIG. 1 (the inner face 60 and the outer face 50, however, differ between FIGS. 1 and 3 due to the respectively differing pattern). The case lid 100 from FIG. 1 also fits to the case (see FIG. 5) to which the case lid 1 fits. Consequently, the case lid 1 and the case lid 100 are interchangeable with regard to the case of the electric motor. The materials from which the case lid 1 is made are the same as described above.

The new design of pattern 30 will now be described:

The pattern 30 is formed on the outer face 50. Moreover, pattern 30 is basically arranged with rotational symmetry and covers the outer face 50 substantially almost entirely, when the pattern 30 defined by first webs 32 and second webs 34 is considered to including the recesses defined therebetween as well. Not entirely enclosed recesses due to being positioned at the edge 19 may thereby also considered as being formed by the first and second webs 32, 34, and thus being part of pattern 30.

The first webs 32 each extend in sections 321, 322, 323 in a radial direction. Starting point for the radial direction is a centre of rotation 70, which is positioned in an axial centre of the above-described opening 20, which is formed within outer face 50. The centre of rotation 70 may be considered as an axis extending through the lid wall 2 or as a point positioned within a plane of the lid wall 2. The opening 20 exclusively serves for fixation of the drive at a frame part, or the roof, of the vehicle, respectively, similar to opening 21. This roof is driven for example by an electric motor 1000 via a gear. An innermost one of the second webs 34 forms a closed first ring 341 around the opening 20. A centre point of the innermost one (ring 341) of the second webs 34 coincides with the centre of rotation 70 in view of the rotational symmetry of the pattern 30. The innermost one of the second webs 34, or ring 341, respectively, is positioned in a region 80 within the outer face 50 near its middle, similar to the centre of rotation 70 and the opening 20. The radial first webs 32 extend starting from the ring 341 radially outward towards edge 19. The region 80 is positioned away in a distance from the edge 19 of the planar lid wall 2.

A second ring 342, a third ring 343 and a fourth ring 344 are arranged concentric with the first ring 341 (i.e., having the same centre point or centre of rotation), and correspond to a second innermost, third innermost and outermost one of the second webs 34, respectively. The distances in a radial direction between respectively adjacent rings are substantially similar or equal to each other. Only the first ring 341 is closed, since the second, third and fourth rings 342-344 would extend beyond the edge 19 of the outer face for geometrical reasons, whereas the pattern 30 is cut off at the edge 19.

From each of the substantially radially extending first webs 32 a first section 321 extends in a radial direction straight and linearly between the first ring 341 and the second ring 342. An angle formed between each two adjacent first sections 321 in the circumferential direction is equal throughout the pattern 30. In the present embodiment there may be provided for example 24 first sections, such that the angle herein may amount to 15°, for example. Other numbers and angles are possible as well. The width of the first section 321 is constant along the radial direction. As can be seen in FIG. 3 a sequence of innermost first recesses 41 arranged in a circumferential direction thereby obtain a mutually identical shape of a ring segment which tapers towards a sharp tip close to the innermost first ring 341. Corresponding to the number of first sections of the first webs 32 there is a number of 24 recesses 41 circumferentially arranged and formed by each two of the first sections 321 and the second ring 342 (the sharp tip of ring-segment-shaped recesses 41 is positioned to define the innermost first ring 341).

Second sections 322 of the radially extending first webs 32 extend between the second ring 342 and the third ring 343. As can clearly be seen from FIG. 3, the second sections 322 are positioned laterally offset in the direction of rotation (circumferential direction) with respect to the first sections 321. The second sections 322 are not positioned within a radial projection of the first sections 321, respectively. Each one first section 321 is associated with each one second section 322, since the number of second sections 322 is identical to the number of first sections 321. According to the invention, however, the numbers may be conceived to be different from each other. The lateral offset in the direction of rotation herein amounts to 7.5°, such that there presently arises a rotational and point symmetric arrangement of first webs 32, if the parts of the pattern 30 cut off at the edge 19 are disregarded. The second sections 322 include an increasing width in a direction outwards along the radial direction. Due to this measure, those recesses 42 defined by the second and third rings 342, 343 and the second sections 322 are provided with a constant width along the radial direction, or a substantially rectangular shape, when viewed from above.

Third sections 323 of the radially extending first webs 32 extend between the third ring 343 and the fourth ring 344. Like the first sections 321 the third sections 323 of the first webs 32 again include a constant width along the radial direction, such that third recesses 43 formed by the third and fourth rings 343 and 344 of the second webs 34 and mutually adjacent third sections 323 of the first webs 32 are again shaped as ring segments. Also, due to a lateral offset, the third sections 323 are positioned outside a radial projection of the second sections 322 which extend adjoining inwards from third sections 323. However, the third sections 323 extend within a radial projection of the first sections 321 of the first webs 32.

As shown in FIG. 3 there are also formed fourth recesses 44, and fourth sections of the radially extending webs 32 are formed in a similar way. However, since these extend only in a radially remote peripheral edge area, these do not play a relevant role for the vibration behaviour of the middle portion of the case lid 1.

As described above, the radially extending webs 32 are composed of sections 321-323, which are arranged along a radial direction and mutually laterally offset in a circumferential direction. These sections are merely connected by transverse webs, which simultaneously function as the second webs 34 (in particular, rings 342 and 343 serve for the connection between the sections), which thus intersect the radially extending first webs 32 in a direction of rotation (circumferential direction). As a result, the pattern 30 does not comprise webs, which extend continuously straight and linearly starting from the central region 80 up to the outer ends thereof terminating at the peripheral edge 19 of the lid wall 2. As a consequence, an efficient propagation of vibrations introduced at the edge and propagating to the central area is impeded and the damping or absorption of the vibrations is improved.

Herein, it is also important that fractions of surface area occupied by first through third sections 321-323 of the radially extending first webs 32 relative to the first through third recesses 41-43 within each of the annular areas between the rings 341 and 342, 342 and 343 as well as 343 and 344 decreases radially outwards from the centre region 80 to the outer edge. Due to the first webs 32 converging inwards the mass in the centre region 80 within the outer face 50 is accumulated and increased. Consequently, the vibration behaviour of the case lid 1 is positively influenced in particular by the combination with the omission of webs which otherwise extend continuously radial from the centre to the peripheral edge.

Recesses 41-44 include a radial length of 9.7 mm, 8.5 mm, 8.1 mm and 11.4 mm when viewed starting from the centre in a direction outwards. The thickness of the lid wall 2 amounts to 1.7 mm in an area of the webs 32, 34 and to 1.1 mm in the area of the recesses 41-44. It means that step height on both sides (inner face 60, outer face 50) amounts to 0.3 mm.

One effect of the invention is that the glass fibers aligning themselves longitudinally on the inside of the injection opening of the corresponding mold during injection molding are even stronger urged into a chaotic orientation at the vertical step formed by the webs. Due to the lateral offset of the radially extending first webs 32 plural vertical steps are formed at which the glass fibers are oriented chaotically. This in turn has a positive effect with regard to a mechanical distortion or warpage upon cooling after the injection mold process as well as with regard to the vibrational behaviour or the propagation of vibrations or oscillations onto and through the lid wall 2.

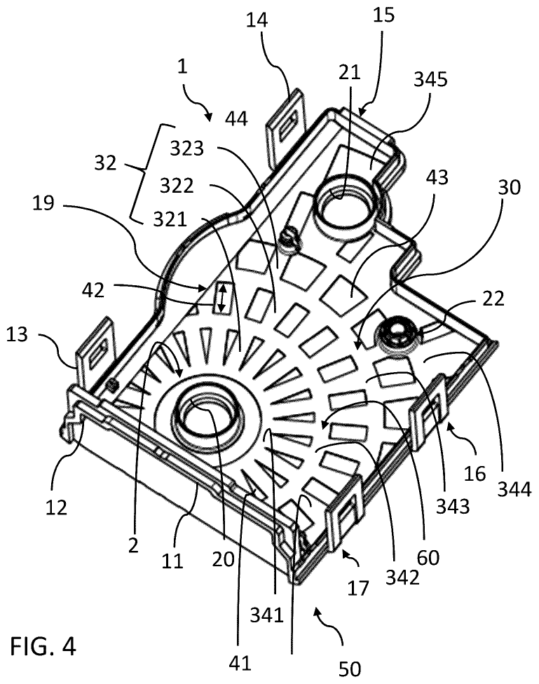

FIG. 4 shows for the same case lid 1 as in FIG. 3 a view of the inner face 60. It can be readily seen that the same or similar pattern 30 is formed in a mirror symmetrical fashion (mirrored via a lid plane of the lid wall 2) with regard to the pattern 30 formed on the outer face 50.

FIG. 5 shows in a perspective view the assembly of the case lid 1 according to the embodiments shown in FIGS. 3 and 4 and a case of an electric motor. The case consists of a gearbox casing 200 and a motor casing 210, which is subsequently attached to the gearbox casing 200 with the motor (stator and rotor) installed in it. A rotor shaft holder is designated by the reference numeral 230.

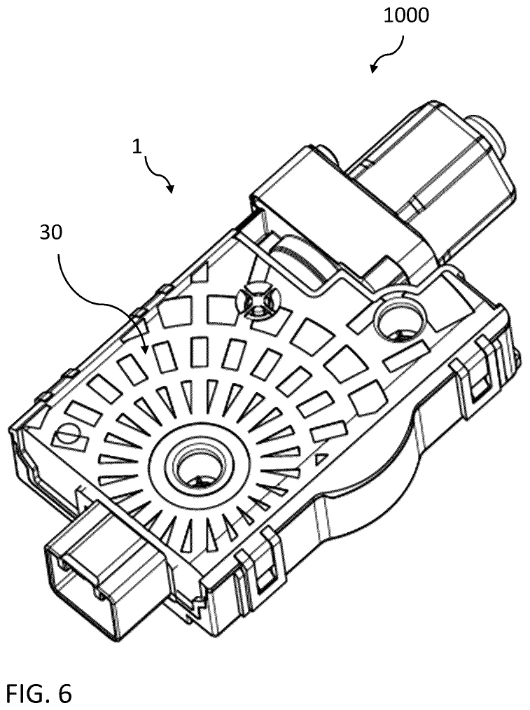

The opening 22 in the case lid 1 has a protrusion towards the inside (i.e. starting from the inner surface 60), as can be seen in FIG. 4. A positioning pin 222 extending upwards from the gearbox casing 200 is inserted into this protrusion when the case lid 1 is placed on the gearbox casing 200, which allows the case lid 1 to be pre-centered during assembly. In the state shown in FIG. 5, a circuit board, which cannot be seen in the perspective of the figure, is already fitted under the case lid 1 as a control unit for the electric motor 1000. The pre-centering protects it from damage during further assembly of the case lid. It also serves primarily to ensure that the Hall sensors on the circuit board are positioned precisely in relation to the motor's magnetic wheel. The hollow cylindrical openings 220 and 221 of the gearbox casing 200 are now also centered on the openings 20 and 21 as the mounting process continues. Furthermore, the engagement structures 13 and 14 (as well as the other lugs mentioned above) finally engage in corresponding engagement structures 213, 214 (latching lugs). A connector or multi-pin header (for the electrical connection of the control unit or circuit board) is designated by the reference numeral 90. The electric motor 1000 assembled in this way is shown in FIG. 6.

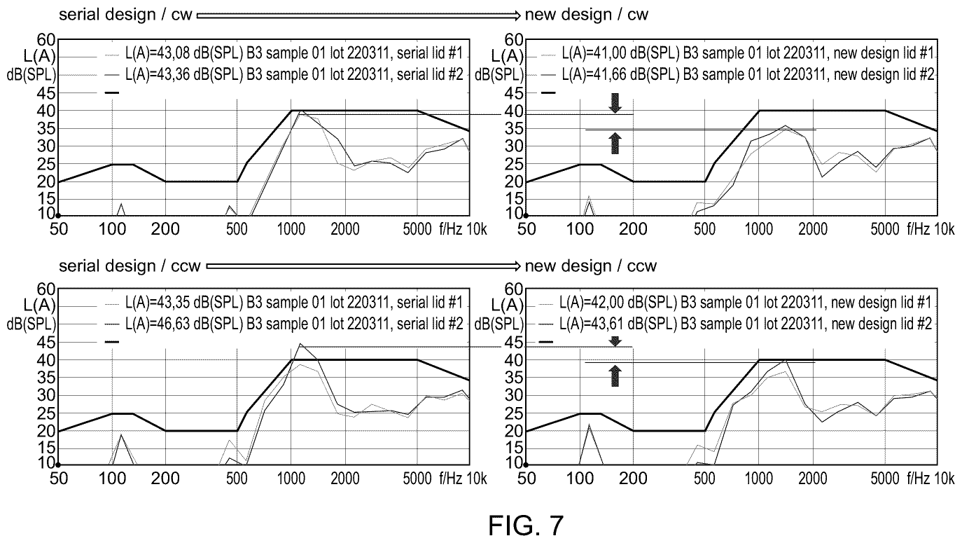

The above-mentioned vibration behavior is shown in FIG. 7. In particular, FIG. 7 shows 4 diagrams with measured noise levels, plotted over a frequency range of 50 Hz to 10 KHz, for two case lids according to the conventional design (diagrams on the left) and according to embodiments of the invention (diagrams on the right), with the upper diagrams relating to cw (clockwise rotating motor) and the lower diagrams relating to ccw (counterclockwise rotating motor). Two samples are recorded in each sub-diagram. The base frequency in the example is 1061 Hz.

It can be clearly seen, that the upper line drawn in bold, which reflects a typical tolerance limit set by a manufacturer of a vehicle, is no more exceeded upon using the case lid 1 having the pattern 30 of the new design (on right side), while the conventional pattern 130 (on the left side) goes beyond the tolerance limit.

### LIST OF REFERENCE NUMERALS

1 case lid
2 lid wall
11-17 engagement structure
18 inclined portion
19 edge of the outer and inner face
20-22 openings
30 pattern
32 substantially radially extending webs
321-323 laterally offset sections of each first web
34 second web intersecting first webs
341-344 first through fourth rings
41-44 recesses between first and second webs
50 outer face
60 inner face
70 centre of rotation
80 region
90 connector, multi-pin-header
100 case lid (comparative example)
130 pattern (comparative example)
132 webs (comparative example)
134 webs (comparative example)
136 recesses (comparative example)
138 distance (comparative example)
139 distance (comparative example)
200 gearbox casing (case)
210 motor casing (case)
213, 214 latching lugs
220, 221 hollow cylindrical openings for screws
222 positioning pin
230 rotor shaft holder
1000 electric motor

1. A case lid for a case assembly of an electric motor for driving a movable component in a vehicle, comprising:
an at least partially planar lid wall having an inner face facing a case of the case assembly in a mounted state and a corresponding outer face facing away from the case, both faces each comprising an edge; and
one or more engagement structures connected with the case lid for coupling corresponding engagement structures provided at the case, in order to close an opening of the case;
wherein a pattern of elevated webs for reinforcing the lid wall and recesses each formed between the webs is arranged on at least one of: the inner face and or the outer face;
wherein the pattern comprises a number of first webs each extending in a substantially radial direction outwards from a region within at least one of: the inner face and the outer face, respectively, to the edge as well as second webs intersecting the first webs, wherein the first webs are each laterally offset in sections thereof along the radial direction.

2. The case lid according to claim 1, wherein
the second webs intersecting the first webs are arranged concentric with respect to each other and extend in a predetermined distance from each other within the inner face or the outer face, respectively, each of the second webs forming a ring.

3. The case lid according to claim 1, wherein
the pattern is arranged having rotational symmetry including a center of rotation, which at least one of: extends through the region within at least one of: the inner face and the outer face, respectively, and is positioned within this region.

4. The case lid according to claim 3, wherein
an opening is formed in a distance from the edge within at least one of: the inner face and the outer face, respectively, and extends through the lid wall, wherein
the center of rotation of the rotational symmetric pattern is positioned in a center of the opening.

5. The case lid according to claim 1, wherein
the pattern of webs and recesses at least partially enclosed by the webs includes a fraction of occupied surface area of at least one of: the inner face and the outer face, respectively, within the planar part of the lid wall of at least 80%.

6. The case lid according to claim 1, wherein
a local fraction of occupied surface area of the first webs and the second webs relative to a surface area occupied by these webs and the recesses at least partially enclosed by the webs substantially decreases from the region within at least one of: the inner face and the outer face, respectively, in a direction radially outwards.

7. The case lid according to claim 1, wherein
the case lid is manufactured from at least one of: a plastic material and a resin and is injection-molded.

8. The case lid according to claim 1, wherein
the case lid is formed as a single piece.

9. The case lid according to claim 1, wherein
the inner face as well as the outer face comprise the pattern arranged in a mutually mirror-symmetrical fashion mirrored via the plane of the lid wall.

10. A case assembly for an electric motor for driving a movable component in a vehicle, comprising a gearbox casing and a motor casing as well as a case lid, the case lid comprising:
an at least partially planar lid wall having an inner face facing a case of the case assembly in a mounted state and a corresponding outer face facing away from the case, both faces each comprising an edge; and
one or more engagement structures connected with the case lid for coupling corresponding engagement structures provided at the case, in order to close an opening of the case;
wherein a pattern of elevated webs for reinforcing the lid wall and recesses each formed between the webs is arranged on at least one of: the inner face and the outer face;
wherein the pattern comprises a number of first webs each extending in a substantially radial direction outwards from a region within at least one of: the inner face and the outer face, respectively, to the edge as well as second webs intersecting the first webs, wherein the first webs are each laterally offset in sections thereof along the radial direction.

11. An electric motor for driving a movable component in a vehicle, comprising a case assembly as well as a gearbox, a control unit and components operated by the control unit, in particular a stator and a rotor, and a case lid comprising:
an at least partially planar lid wall having an inner face facing a case of the case assembly in a mounted state and a corresponding outer face facing away from the case, both faces each comprising an edge; and
one or more engagement structures connected with the case lid for coupling corresponding engagement structures provided at the case, in order to close an opening of the case;
wherein a pattern of elevated webs for reinforcing the lid wall and recesses each formed between the webs is arranged on at least one of: the inner face and the outer face;
wherein the pattern comprises a number of first webs each extending in a substantially radial direction outwards from a region within at least one of: the inner face and the outer face, respectively, to the edge as well as second webs intersecting the first webs, wherein the first webs are each laterally offset in sections thereof along the radial direction.

12. The case lid according to claim 5, wherein the fraction of occupied surface area of at least one of: the inner face and the outer face, respectively, within the planar part of the lid wall of at least 90%.

13. The case lid according to claim 6, wherein in case of rotational symmetry, a local fraction of an inner ring area close to and around the center of rotation amounts to more than 60% in a ring area positioned comparatively more distantly outwards from the center of rotation.

14. The case lid according to claim 6, wherein in case of rotational symmetry, a local fraction of an inner ring area close to and around the center of rotation amounts to more than 80% in a ring area positioned comparatively more distantly outwards from the center of rotation.

15. The case lid according to claim 6, wherein in case of rotational symmetry, a local fraction of an inner ring area close to and around the center of rotation amounts to less than 40% in a ring area positioned comparatively more distantly outwards from the center of rotation.
